(19) United States
(12) Patent Application Publication
(10) Pub. No.: US 2025/0173816 A1
(43) Pub. Date: May 29, 2025

(54) Noise Schedules, Losses, and Architectures for Generation of High-Resolution Imagery with Diffusion Models

(71) Applicant: Google LLC, Mountain View, CA (US)

(72) Inventors: Emiel Hoogeboom, Amsterdam (NL); Tim Salimans, Utrecht (NL); Jonathan Heek, Hilversum (NL)

(21) Appl. No.: 19/039,664

(22) Filed: Jan. 28, 2025

Related U.S. Application Data
(63) Continuation of application No. PCT/US2024/012929, filed on Jan. 25, 2024.
(60) Provisional application No. 63/481,711, filed on Jan. 26, 2023.

(51) Int. Cl. G06T 3/40; G06T 5/60; G06T 5/70; G06T 11/00

(52) U.S. Cl. CPC G06T 3/40; G06T 5/60; G06T 5/70; G06T 11/00; G06T 2207/20081; G06T 2207/20084

(57) ABSTRACT

The present disclosure relates generally to machine learning. More particularly, the present disclosure relates to improved noise schedules, losses, and architectures for generation of high-resolution imagery with diffusion models.

### RELATED APPLICATIONS

This application is a continuation of International Application No. PCT/US2024/012929 filed on Jan. 25, 2024, which claims priority to and the benefit of U.S. Provisional Patent Application No. 63/481,711, filed Jan. 26, 2023. Each of International Application No. PCT/US2024/012929 and U.S. Provisional Patent Application No. 63/481,711 is hereby incorporated by reference in its entirety.

### FIELD

The present disclosure relates generally to machine learning. More particularly, the present disclosure relates to improved noise schedules, losses, and architectures for generation of high-resolution imagery with diffusion models.

### BACKGROUND

Currently, denoising diffusion applied directly in pixel space of high resolution images is difficult. Instead, existing approaches focus on diffusion in lower dimensional spaces (latent diffusion), or have multiple super-resolution levels of generation referred to as cascades. The downside is that these approaches add additional complexity to the diffusion framework.

More particularly, score-based diffusion models have become increasingly popular for data generation. In essence the idea is simple: one pre-defines a diffusion process, which gradually destroys information by adding random noise. Then, the opposite direction defines the denoising process, which is approximated with a neural network.

Diffusion models have shown to be extremely effective for image, audio, and video generation. However, for higher resolutions the literature typically operates on lower dimensional latent spaces (latent diffusion) or divides the generative process into multiple sub-problems, for instance via super-resolution (cascaded diffusion) or mixtures-of-denoising-experts. The disadvantage is that these approaches introduce additional complexity and usually do not support a single end-to-end training setup.

### SUMMARY

Aspects and advantages of embodiments of the present disclosure will be set forth in part in the following description, or can be learned from the description, or can be learned through practice of the embodiments.

One example aspect of the present disclosure is directed to a computing system configured to perform image generation, the computing system comprising: one or more processors; and one or more non-transitory computer-readable media. The one or more non-transitory computer-readable media collectively store a machine-learned denoising diffusion model. The machine-learned denoising diffusion model comprises: a first downsampling block configured to process an input and perform a first downsampling operation to generate a first downsampled output; a second downsampling block configured to process the first downsampled output and perform a second downsampling operation to generate a second downsampled output; a transformer block configured to perform self-attention on the second downsampled output to generate a transformer output; a first upsampling block configured to process the transformer output and perform a first upsampling operation to generate a first upsampling output; and a second upsampling block configured to process the first upsampling output and perform a second upsampling operation to generate a second upsampling output. The one or more non-transitory computer-readable media collectively store instructions that, when executed by the one or more processors, cause the computing system to use the machine-learned denoising diffusion model configured to generate images.

In some implementations, the first downsampling block and the second upsampling block do not perform self-attention.

In some implementations, the first downsampling block and the second upsampling block perform only convolutional operations.

In some implementations, the transformer block is repeated multiple times.

In some implementations, the machine-learned denoising diffusion model sequentially applies channel multipliers of 1, 2, and 4.

One example aspect of the present disclosure is directed to a computer-implemented method to control a machine-learned diffusion model for improved image generation. The method includes obtaining, by a computing system comprising one or more computing devices, data descriptive of a specified resolution for synthetic images to be generated by the machine-learned diffusion model. The method includes accessing, by the computing system, a noise schedule generation algorithm that outputs an output noise schedule based on an input resolution, wherein an output signal to noise ratio associated with the output noise schedule is inversely correlated to a magnitude of the input resolution. The method includes performing, by the computing system, the noise schedule generation algorithm with the specified resolution as the input resolution to generate a resolution-specific noise schedule for the machine-learned diffusion model. The method includes employing, by the computing system, the machine-learned diffusion model to generate the synthetic images of the specified resolution according to the resolution-specific noise schedule.

In some implementations, performing, by the computing system, the noise schedule generation algorithm with the specified resolution as the input resolution comprises: obtaining, by the computing system, a reference signal to noise ratio associated with a reference noise schedule associated with a reference resolution; determining, by the computing system, a scaling value based on the reference resolution and the specified resolution, wherein a magnitude of the scaling value is correlated to a ratio of the reference resolution to the specified resolution; and scaling, by the computing system, the reference signal to noise ratio by the scaling value to obtain a resolution-specific signal to noise ratio for the resolution-specific noise schedule.

In some implementations, the scaling value comprises a square of the reference resolution ratio of the reference resolution to the specified resolution.

In some implementations, the reference resolution is smaller than the specified resolution.

In some implementations, the reference resolution comprises 64 pixels by 64 pixels.

In some implementations, performing, by the computing system, the noise schedule generation algorithm with the specified resolution as the input resolution comprises: obtaining, by the computing system, a first reference signal to noise ratio associated with a first reference noise schedule associated with a first reference resolution; determining, by the computing system, a first scaling value based on the first reference resolution and the specified resolution, wherein a magnitude of the first scaling value is correlated to a first ratio of the first reference resolution to the specified resolution; scaling, by the computing system, the first reference signal to noise ratio by the first scaling value to obtain a first resolution-specific signal to noise ratio; obtaining, by the computing system, a second reference signal to noise ratio associated with a second reference noise schedule associated with a second, different reference resolution; determining, by the computing system, a second scaling value based on the second reference resolution and the specified resolution, wherein a magnitude of the second scaling value is correlated to a second ratio of the second reference resolution to the specified resolution; and scaling, by the computing system, the second reference signal to noise ratio by the second scaling value to obtain a second resolution-specific signal to noise ratio; wherein the resolution-specific noise schedule comprises an interpolated schedule that interpolates between the first resolution-specific signal to noise ratio and the second resolution-specific signal to noise ratio.

In some implementations, the machine-learned diffusion model has been trained using a multi-scale training loss that evaluates loss values between downsampled versions of a training input and a predicted output at multiple reduced resolutions.

Another example aspect is directed to a computer-implemented method for improved training of diffusion models for image synthesis via multi-scale training loss. The method includes accessing, by a computing system comprising one or more computing devices, a training input associated with a training image. The method includes employing, by the computing system, a diffusion model to generate a predicted output associated with a synthetic image based at least in part on the training input associated with the training image. The method includes evaluating, by the computing system, a multi-scale loss function based on the training input associated with the training image and the predicted output associated with the synthetic image. Evaluating the multi-scale loss function comprises: downsampling both the training input and the predicted output to a plurality of reduced resolutions; evaluating a plurality of loss values between the training input and the predicted output respectively at the plurality of reduced resolutions; and aggregating the plurality of loss values to generate an aggregate loss value. The method includes updating, by the computing system, one or more parameters of the diffusion model based at least in part on the aggregate loss value.

In some implementations, aggregating the plurality of loss values to generate the aggregate loss value comprises weighting each loss value by a weighting coefficient, wherein a magnitude of the weighting coefficient applied to the loss value at each reduced resolution is inversely correlated to the reduced resolution.

In some implementations, the training input and the predicted output comprise respective epsilon values.

In some implementations, the diffusion model operates according to a resolution-specific noise schedule.

Another example aspect is directed to a computing system configured to perform any of the methods described herein.

Another example aspect is directed to one or more non-transitory computer-readable media that store a diffusion model configured to implement a resolution-specific noise schedule determined according to any of the methods described herein and/or trained according to any of the methods described herein.

Another example aspect is directed to one or more non-transitory computer-readable media that store a diffusion model comprising a plurality of diffusion layers, wherein at least one of the diffusion layers comprises a UVit architecture comprising an MLP block and self-attention, but no convolutional operations, at a 16×16 resolution.

Another example aspect is directed to one or more non-transitory computer-readable media that store a diffusion model comprising a plurality of diffusion layers, wherein at least one of the diffusion layers is configured to perform dropout at one or more lower resolution feature maps but to not perform dropout at one or more higher resolution feature maps.

Although aspects of the present disclosure are described with reference to image synthesis and resolutions, they are also applicable to generation of other forms of content (e.g., videos, audio, audiovisual content, multi-media content, etc.) having various content sizes (e.g., length, data size, fidelity, etc.). Therefore, one example aspect of the present disclosure is directed to computer-implemented method to control a machine-learned diffusion model for improved content generation. The method includes obtaining, by a computing system comprising one or more computing devices, data descriptive of a specified content size for synthetic content to be generated by the machine-learned diffusion model. The method includes accessing, by the computing system, a noise schedule generation algorithm that outputs an output noise schedule based on an input content size, wherein an output signal to noise ratio associated with the output noise schedule is inversely correlated to a magnitude of the input content size. The method includes performing, by the computing system, the noise schedule generation algorithm with the specified content size as the input content size to generate a content size-specific noise schedule for the machine-learned diffusion model. The method includes employing, by the computing system, the machine-learned diffusion model to generate the synthetic content of the specified content size according to the content size-specific noise schedule.

In some implementations, performing, by the computing system, the noise schedule generation algorithm with the specified content size as the input content size comprises: obtaining, by the computing system, a reference signal to noise ratio associated with a reference noise schedule associated with a reference content size; determining, by the computing system, a scaling value based on the reference content size and the specified content size, wherein a magnitude of the scaling value is correlated to a ratio of the reference content size to the specified content size; and scaling, by the computing system, the reference signal to noise ratio by the scaling value to obtain a content size-specific signal to noise ratio for the content size-specific noise schedule.

Another example aspect is directed to a computer-implemented method for improved training of diffusion models for content synthesis via multi-scale training loss. The method includes accessing, by a computing system comprising one or more computing devices, a training input associated with a training content. The method includes employing, by the computing system, a diffusion model to generate a predicted output associated with a synthetic content based at least in part on the training input associated with the training content. The method includes evaluating, by the computing system, a multi-scale loss function based on the training input associated with the training content and the predicted output associated with the synthetic content. Evaluating the multi-scale loss function comprises: downsampling both the training input and the predicted output to a plurality of reduced content sizes; evaluating a plurality of loss values between the training input and the predicted output respectively at the plurality of reduced content sizes; and aggregating the plurality of loss values to generate an aggregate loss value. The method includes updating, by the computing system, one or more parameters of the diffusion model based at least in part on the aggregate loss value.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 illustrates plot diagrams of example noise schedules according to example embodiments of the present disclosure.

FIG. 2 illustrates a plot diagram of a log signal to noise ratio for an original and an example proposed shifted cosine schedule according to example embodiments of the present disclosure.

FIG. 3 illustrates graphical diagrams of an example U-Net architecture and an example U-ViT architecture according to example embodiments of the present disclosure.

FIG. 4A depicts a block diagram of an example computing system according to example embodiments of the present disclosure.

FIG. 4B depicts a block diagram of an example computing device according to example embodiments of the present disclosure.

FIG. 4C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to systems and methods that improve denoising diffusion for high resolution images while keeping the model as simple as possible. According to one aspect of the present disclosure, techniques are provided that enable the noise schedule of the diffusion model to be adjusted for high resolution images. According to another aspect, diffusion model architectures are provided in which only a particular part (e.g., at the 16×16 resolution) of the architecture is scaled larger. According to another aspect, diffusion model architectures are provided in which dropout is added at specific locations in the architecture (e.g., at lower resolution layers but not higher resolution layers). Another aspect of the present disclosure provides downsampling as an effective strategy to avoid high resolution feature maps. Combining these simple yet effective techniques, example implementations of the present disclosure achieve state-of-the-art on image generation among denoising diffusion models without guidance on ImageNet.

The systems and methods of the present disclosure provide a number of technical effects and benefits. In particular, the systems and methods described herein enable the generation of high quality synthetic imagery at a relatively higher-resolution by a diffusion model, but without requiring the diffusion model itself to be scaled significantly larger. That is, current diffusion models do not perform well when tasked with generating imagery at higher resolutions. One approach to improving diffusion model performance on such higher resolution imagery would be to scale the diffusion model (e.g., by adding significantly more parameters/layers/etc.). However, scaling the diffusion model (e.g., by adding significantly more parameters/layers/etc.) would result in increased consumption of computational resources such as memory space, processor cycles, and/or network bandwidth. By enabling the generation of high quality synthetic imagery at a relatively higher-resolution by a diffusion model, but without requiring the diffusion model itself to be scaled significantly larger, the systems and methods of the present disclosure can avoid such increased consumption of computational resources. Stated differently, the systems and methods of the present disclosure can conserve computational resources that would otherwise have been spent.

With reference now to the Figures, example embodiments of the present disclosure will be discussed in further detail.

### Example Diffusion Models

A diffusion model generates data by learning the reverse of a destruction process. Commonly, the diffusion process gradually adds Gaussian noise over time. It is convenient to express the process directly in the marginals q(zₜ|x) which is given by:

$$q ( {z}_{t} \vert x ) = N ( {z}_{t} \vert {α}_{t} x , {σ}_{t}^{2} I ) \qquad ( 1 )$$

where αₜ, σₜ∈(0,1) are hyperparameters that determine how much signal is destroyed at a timestep t, which can be continuous for instance t∈[0,1]. Here, αₜ is decreasing and σₜ is increasing, both larger than zero. Some example models can employ a variance preserving process, which fixes the relation between αₜ, σₜ to be αₜ²=1−σₜ². Assuming the diffusion process is Markov, the transition distributions are given by:

$$q ( {z}_{t} \vert {z}_{s} ) = N ( {z}_{t} \vert {α}_{ts} {z}_{s} , {σ}_{ts}^{2} I ) \qquad ( 2 )$$

where αₜₛ=αₜ/αₛ and σₜₛ²=σₜ²−α_{t|s}²σₛ² and t>s.

Noise schedule: An often used noise schedule is the α-cosine schedule where αₜ=cos(πt/2) which under the variance preserving assumption implies σₜ=sin(πt/2). The signal-to-noise ratio αₜ/σₜ is impactful, which is then 1/tan(πt/2) or in log space

$$log \frac{{α}_{t}}{{σ}_{t}} = - log tan ( π t / 2 ) .$$

Denoising: Conditioned on a single datapoint x, the denoising process can be written as:

$$q ( {z}_{s} \vert {z}_{t} , x ) = N ( {z}_{t} \vert {μ}_{t \to s} , {σ}_{t \to s}^{2} I ) . \qquad ( 3 )$$

where

$${μ}_{t \to s} = \frac{{α}_{ts} {σ}_{s}^{2}}{{σ}_{t}^{2}} {z}_{t} + \frac{{α}_{s} {σ}_{ts}^{2}}{{σ}_{t}^{2}} x$$

$$and$$

$${σ}_{t \to s} = \frac{{σ}_{ts}^{2} {σ}_{s}^{2}}{{σ}_{t}^{2}} .$$

When x is approximated by a neural network \hat{x}=f_{θ}(zₜ), then one can define the learned distribution p(zₛ|zₜ)=q(zₛ|zₜ, x=\hat{x}) without loss of generality as s→t. This works because as s→t, the true denoising distribution for all datapoints q(zₛ|zₜ) (which is typically unknown) will become equal to q(zₛ|zₜ,x= [symbol] [x|zₜ]).

Parametrization: The network does not need to approximate \hat{x} directly, and experimentally it has been found that other predictions produce higher visual quality. Studying the re-parametrization of the marginal q(zₜ|x) which is zₜ=αₜx+σₜεₜ where εₜ˜ [symbol] (0,1), one can for instance choose the epsilon parametrization where the neural net predicts \hat{ε}ₜ. To obtain \hat{x}, one computes \hat{x}=zₜ/αₜ−σₜ\hat{ε}ₜ/αₜ. The problem with the epsilon parametrization is that it gives unstable sampling near t=1. An alternative parametrization without this issue is called v prediction, which is defined as \hat{v}ₜ=αₜ\hat{ε}ₜ−σₜ\hat{x}.

Note that given zₜ one can obtain \hat{x} and \hat{ε}ₜ via the identities σₜzₜ+αₜ\hat{v}ₜ=(σₜ²+αₜ²)\hat{ε}ₜ=\hat{ε}ₜ and αₜzₜ−σₜ\hat{v}ₜ=(αₜ²+σₜ²)\hat{x}=\hat{x}. In initial experiments, v prediction was found to train more reliably, especially for larger resolutions, and therefore this parametrization can be used for implementations described herein.

Optimization: To train the model, some example implementations can use the standard epsilon loss. A way to motivate this choice of loss, is that using variational inference one can derive a lower-bound (in continuous time) on the model log-likelihood as follows:

$$\begin{matrix}log p ( x ) = log {𝔼}_{q} \frac{p ( x , {z}_{0} , … , {z}_{1} )}{q ( {z}_{0} , … , {z}_{1} \vert x )} \geq {𝔼}_{q} log \frac{p ( x , {z}_{0} , … , {z}_{1} )}{q ( {z}_{0} , … , {z}_{1} \vert x )} \\ = {ℒ}_{x} + {ℒ}_{T} - {𝔼}_{t ∼ 𝒰 ( 0 , 1 )} [ w ( t ) {‖ {ε}_{t} - {\hat{ε}}_{t} ‖}^{2} ] ,\end{matrix}$$

where for a well-defined process [symbol] =−logp(x|z₀)≈0 discrete x, [symbol] =−KL(q(zₜ|x)|p(z_{T}))≈0, and where w(t) is a weighting function which for the equation to be true needs to be

$$w ( t ) = - \frac{d}{dt} log SNR ( t )$$

where SNR(t)=αₜ²/σₜ². In practice, some example implementations generally use the unweighted loss on εₜ (meaning that w(t)=1) which gives superior sample quality.

### Example Approaches for Adjusting Noise Schedules

One possible modification is the noise schedule that is typically used for diffusion models. The most common schedule is the a-cosine schedule, which under the variance preserving assumption amounts to

$$\frac{{σ}_{t}}{{α}_{t}} = tan ( π t / 2 )$$

(ignoring the boundaries around t=0 and t=1 for this analysis. This schedule was originally proposed to improve the performance on CIFAR10 which has a resolution of 32×32 and ImageNet 64×64.

However, for high resolutions not enough noise is added. For instance, for the standard cosine schedule, the global structure of the image is largely defined already for a wide range in time. This is problematic because the generative denoising process only has a small time window to decide on the global structure of the image. Therefore, according to an aspect of the present disclosure, this schedule can be changed so as to retain good visual sample quality.

To illustrate this need in more detail, let us study a 128×128 problem. Given an input image x the diffusion distribution for pixel i is given by q(zₜ⁽ⁱ⁾|x)= [symbol] (zₜ⁽ⁱ⁾|αₜxᵢ, σₜ). Commonly, diffusion models use network architectures that use downsampling to operate on lower resolution feature maps, for example with average pooling. Suppose we average pool zₜ, where we let indices 1,2,3,4 denote the pixels in a 2×2 square that is being pooled. This new pixel is zₜ^{64×64}=(zₜ⁽¹⁾+zₜ⁽²⁾+zₜ⁽³⁾+zₜ⁽⁴⁾)/4. Recall that for variance of independent random variables is additive meaning that Var[X₁+X₂]=Var[X₁]+Var[X₂] and that Var[aX]=a²Var[X] for a constant a. Letting x^{64×64} denote the first pixel of the average pooled input image, we find that z^{64×64}˜ [symbol] (αₜx^{64×64}, σₜ/2). The lower resolution pixel zₜ^{64×64} only has half the amount of noise. We hypothesize that as resolutions increase this is problematic, as much less diffusion time is spent on the lower resolution, a stage at which the global consistency is generated.

It can be further derived that the αₜ to σₜ ratio at this lower resolution is twice as high, meaning that the signal to noise ratio is 2² as high. And so SNR^{64×64}(t)=SNR^{128×128}(t)·2², or in general:

$${SNR}^{d / s \times d / s} ( t ) = {SNR}^{d \times d} ( t ) \cdot {s}^{2}$$

In summary, after averaging over a window of size s×s, the ratio αₜ to σₜ increases by a factor s (and thus the SNR by s²). Hence, the present disclosure proposes that the noise schedule could be defined with respect to some reference resolution, say 32×32 or 64×64 for which the schedules were initially designed and successfully tested. In example approaches provided herein: one first chooses a reference resolution, for example 64×64 (a reasonable choice as shown empirically). At the reference resolution the noise schedule can be defined: SNR^{64×64}(t)=1/tan(πt/2)² which in turn defines the desired SNR at full resolution d×d:

$${SNR}_{shift 64}^{d \times d} ( t ) = {SNR}^{64 \times 64} ( t ) \cdot ( \frac{64}{{d )}^{2}} , \qquad ( 5 )$$

the signal to noise ratio is simply multiplied by (64/d)², which for the example setting d>64 reduces the signal-to-noise ratio at high resolution. In log-space, this implies a simple shift of 2·log(64/d). For example, the equation of a noise schedule for images of 128×128 and a reference resolution of 64 the schedule is:

$$log {SNR}_{shift 64}^{128 \times 128} ( t ) = - 2 log tan ( π t / 2 ) + 2 log ( 64 / 128 ) .$$

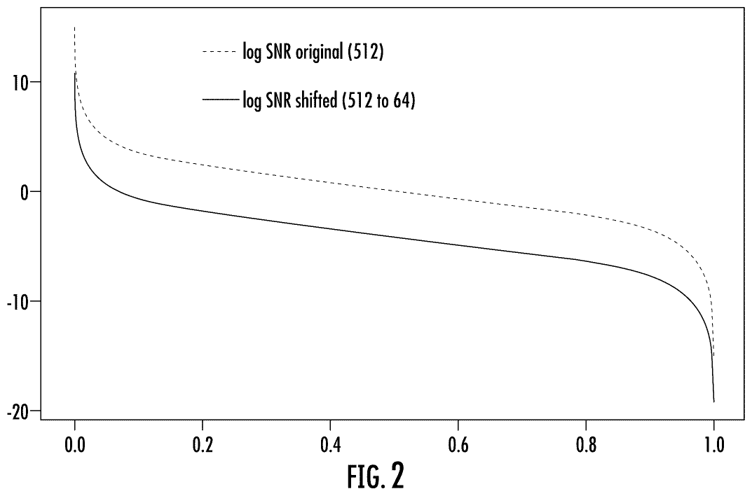

As one example, FIG. 2 illustrates a plot diagram of a log signal to noise ratio for an original and an example proposed shifted cosine schedule.

Recall that under a variance preserving process, the diffusion parameters can be computed as αₜ²=sigmoid(logSNR(t)) and σₜ²=sigmoid(−logSNR(t)).

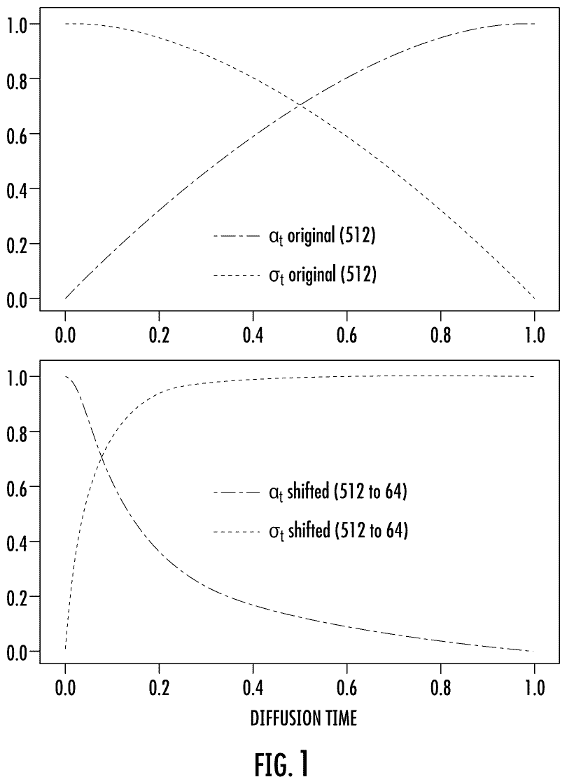

As an example of the concepts discussed above, FIG. 1 illustrates plot diagrams of example noise schedules. Specifically, the top plot shows a conventional cosine schedule while the bottom plot shows an example proposed shifted schedule.

Interpolating schedules: A potential downside of shifting the schedule is that high frequency details are now generated much later in the diffusion process due to the increased per-pixel noise. However, high-frequency details are weakly correlated when conditioning on the global/low-frequency features that are already generated. It should therefore be possible to generate the high-frequency details in few diffusion steps. Alternatively, one can interpolate different shift schedules, for example for a resolution of 512 one could include higher frequency details by starting at shift 32 and interpolating in log-space to shift 256. The schedule for logSNR_{interpolate(32→256)}(t) equals:

$$t log {SNR}_{shift 256}^{512 \times 512} ( t ) + ( 1 - t ) log {SNR}_{shift 32}^{512 \times 512} ( t ) \qquad ( 6 )$$

which has more equal weighting over low, mid and high frequency details. When sampling guidance is desired (for example in our text to image experiments) this interpolated schedule can optionally be used.

### Example Multiscale Training Loss

The last section described that the noise schedule of diffusion models can be adjusted when training on high resolution images so that the signal-to-noise ratio at our base resolution is held constant. However, even when adjusting the noise schedule in this way, the training loss on images of increasingly high resolution is dominated by high frequency details. To correct for this some example implementations can replace the standard training loss by a multiscale version that evaluates the standard training loss at downsampled resolutions with a weighting factor that increases for the lower resolutions. The multiscale loss enables quicker convergence especially at resolutions greater than 256×256. An example training loss at the d×d resolution can be written as:

$${L}_{θ}^{d \times d} ( x ) = \frac{1}{{d}^{2}} {𝔼}_{ε , t} {‖ {D}^{d \times d} [ ε ] - {D}^{d \times d} [ {\hat{ε}}_{θ} ( {α}_{t} x + {σ}_{t} ε , t ) ] ‖}_{2}^{2} ,$$

where D^{d×d} denotes downsampling to the d×d resolution. If this resolution is identical to the native resolution of our model \hat{ε}_{θ} and data x, the downsampling does not do anything and can be removed from this equation. Otherwise, D^{d×d}[\hat{ε}_{θ}] can be considered as an adjusted denoising model for data at non-native resolution d×d. Since downsampling an image is a linear operation, we have that D^{d×d}[ [symbol] (ε|x)]= [symbol] (D^{d×d}[ε]|x).

Some example implementations train the high resolution model against the multiscale training loss comprising of multiple resolutions. For instance for the resolutions 32,64, . . . , d the loss would be:

$${\tilde{L}}_{θ}^{d \times d} ( x ) = {\sum }_{s ∈ \{ 32 , 64 , 128 , … , d \}} \frac{1}{s} {L}_{θ}^{s \times s} ( x ) .$$

That is, some example implementations train against a weighted sum of training losses for resolutions starting at a base resolution (in this case 32×32) and always including the final resolution of d×d. Losses for higher resolution are noisier on average, and therefore some example implementations can decrease the relative weight of the loss as the resolution increases.

### Example Approaches for Scaling the Architecture

Another question is how to scale the architecture. Typical model architectures half the channels each time the resolution is doubled such that the flops per operation is the same but the number of features doubles. The computational intensity (flops/features) also halves each time the resolution doubles. Low computational intensity leads to poor utilization of the accelerator and large activations result in out-of-memory issues. As such, some example implementations scale on the lower resolution feature maps. The present disclosure proposes that mainly scaling on a particular resolution, namely the 16×16 resolution is sufficient to improve performance within a range of network sizes we consider. Typically, low resolution operations have relatively small feature maps. To illustrate this, consider for example

$$1024 ( batch ) \times 16 \times 16 \times 1024 ( channel ) \cdot 2 bytes / dim$$

costs 0.5 GB for a feature map whereas for a 256×256 feature map with 128 channels, a feature map costs 16 GB, given they are stored in a 16 bit float format.

Parameters have a smaller memory footprint: The typical size of a convolutional kernel is 3²×128²dimensions·4bytes/dims·5replications=2.8 MB and 180 MB for 1024 channels, with 5 replications for the gradient, optimizer state and exponential moving average. The point is, at a resolution of 16×16 both the size of feature maps are manageable at 16² and the required space for the parameters is manageable. Summarizing this simplified calculation in Table 1 one can see that for the same memory constraint, one can fit 16 GB/0.7 GB≈23 layers at 16×16 versus only 1 at 256×256.

Table 1: Memory and compute for a convolutional layer at the typical sizes encountered in diffusion architectures. Using more channels is usually much cheaper at lower resolutions in terms of memory, B=1024 for this example.

| Size | (B × 256² × 128) | (B × 16² × 1024) |
|---|---|---|
| Conv Kernel Memory | 2.8 MB | 180 MB |
| Feature Map Memory | 16 GB | 0.5 GB |
| Total Memory | 16 GB | 0.7 GB |
| Compute (TFLOPS) | 9 | 2.3 |

Other reasons to choose this resolution is because it is the one at which self-attention starts being used in numerous implementations. Furthermore, it is the 16×16 resolution at which vision transformers for classification can operate successfully. Although this may not be the ideal way to scale the architecture, it has been shown empirically that scaling the 16×16 level works well.

In some situations, when using multiple devices naively, parameters are replicated or stored on the first device. Both cases result in a situation where the memory requirements per device for the feature maps decreases with 1/devices as desired, but the parameter requirement is unaffected and requires a lot of memory. Some example implementations scale mostly at a low resolution where activations are relatively small but parameter matrices are large O(features²). In some implementations, sharding the weights allows scaling to much larger models without requiring more complicated parallelization approaches like model parallelism.

Avoiding high resolution feature maps:

High resolution feature maps are memory expensive. If the number of FLOPs is kept constant, memory still scales linearly with the resolution.

In practice, it is not possible to decrease the channels beyond a certain size without sacrificing accelerator utilization. Modern accelerators have a very high ratio between compute and memory bandwidth. Therefore, a low channel count can make operation memory bound, causing a mostly idling accelerator and worse than expected wall-clock performance.

To avoid doing computations on the highest resolutions, some example implementations can down-sample images immediately as a first step of the neural network, and up-sample as the last step. Surprisingly, even though the neural networks are cheaper computationally and in terms of memory, it was shown empirically that they also achieve better performance.

One example approach is to use the invertible and linear 5/3 wavelet (as used in JPEG2000) to transform the image to lower resolution frequency responses. Here, the different feature responses are concatenated spatially for visual purposes. In the network, the responses are concatenated over the channel axis. When more than one level of DWT is applied (here there are two), then the responses differ in resolution. This is resolved by finding the lowest resolution (e.g., 128²) and reshaping pixels for the higher resolution feature maps, in the case of 256² they are reshaped 128²×4, as a typical space to depth operations.

Another example solution is simpler but results in a small performance penalty. As a first layer one can use a d×d convolutional layer with stride d, and an identically shaped transposed convolutional layer as a last layer. This is equivalent to what is called patching in transformer literature. Empirically this performs similarly, albeit slightly worse.

### Example Dropout Approaches

In some architectures typically used in diffusion, a global dropout hyperparameter is used for the residual blocks, at all resolutions. In other cases, dropout is used to generate images at lower resolutions. For the conditional higher resolution images, no dropout is used. However, various other forms of augmentation are performed on the data. This indicates that regularization is important, even for models operating on high resolutions. However, as recognized by the present disclosure, the naive method of adding dropout in all residual blocks does not give desired results.

According to an aspect of the present disclosure, since example network designs proposed herein only scale the network size at lower resolutions, it should be sufficient to only add dropout add the lower resolutions. This avoids regularizing the high resolution layers which are memory-wise expensive, while still using the dropout regularization that has been successful for models trained on lower resolution images.

### Example U-ViT Architecture

In some implementations, the above described changes to the architecture can be taken further: the convolutional layers can optionally be replaced with MLP blocks (e.g., if the architecture already uses self-attention at that resolution). This bridges the transformers for diffusion with U-Nets, replacing its backbone with a transformer. Consequently, this relatively small change means that example implementations of the present disclosure use transformer blocks at these resolutions. One benefit is that the combination of self-attention and MLP blocks has high accelerator utilization, and thus large models train somewhat faster.

In essence, this U-Vision Transformer (U-ViT) architecture can be seen as a small convolutional U-Net which through multiple levels down-samples to the 16×16 resolution. At this stage a large transformer is applied after which the upsampling is again done via the convolutional U-Net.

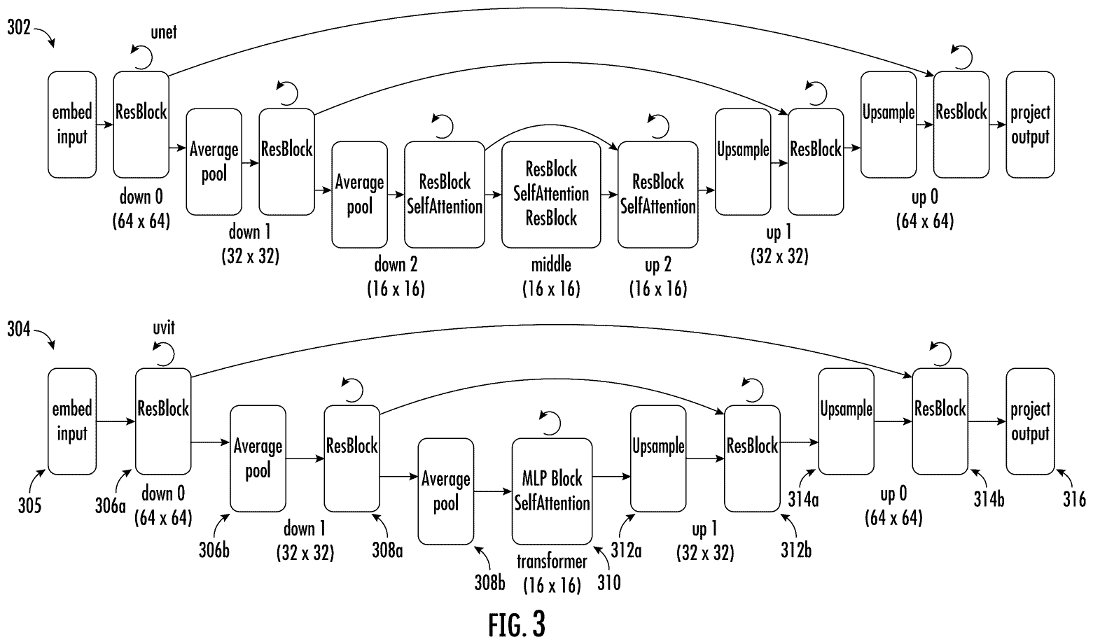

The U-ViT is a similar architecture to the U-Net. FIG. 3 provides a comparison of an example U-Net and an example U-ViT. In the illustrated example, the convolutional layers are replaced by MLP blocks on levels with self-attention. These now form transformer blocks which are connected via residual connections, only the ResBlocks on higher levels use skip connections. Circular arrows denote that such a block can be repeated multiple times.

Thus, two major differences are that 1) When a module has self-attention, it uses an MLP block instead of a convolutional layer, making their combination a transformer block. And 2) the transformer blocks in the middle do not use skip connections, only residual connections.

Thus, as illustrated in FIG. 3, an example U-VIT 304 can include: A first downsampling block 306a-b configured to process an input 305 and perform a first downsampling operation 306b to generate a first downsampled output; A second downsampling block 308a-b configured to process the first downsampled output and perform a second downsampling operation 308b to generate a second downsampled output; A transformer block 310 configured to perform self-attention on the second downsampled output to generate a transformer output; A first upsampling block 312a-b configured to process the transformer output and perform a first upsampling operation 312a to generate a first upsampling output; and A second upsampling block 314a-b configured to process the first upsampling output and perform a second upsampling operation 314a to generate a second upsampling output 316.

In some implementations, the first downsampling block 306a-b and the second upsampling block 314a-b do not perform self-attention. In some implementations, the first downsampling block 306a-b and the second upsampling block 314a-b perform only convolutional operations. In some implementations, the transformer block 310 is repeated multiple times. In some implementations, the U-ViT 304 sequentially applies channel multipliers of 1, 2, and 4.

Additional example optimization settings and pseudocode for an example U-ViT are contained in the Appendix of U.S. Provisional Patent Application No. 63/481,711, which is hereby incorporated by reference in its entirety.

### Example Text to Image Generation Approaches

A diffusion model can be trained conditioned on text data. As one example, the T5 XXL text encoder can be used as conditioning. Three example models can be trained as follows: One on images of resolution 256×256 for a direct comparison to models in literature, one on 512×512 and one on 384×640. For the last, non-square resolution, images can be rotated during prepossessing if their width is smaller than their height, along which a ‘portrait mode’ flag is set to true. As a result, this model can generate natively in a 5:3 aspect ratio for both landscape and portrait orientation.

### Example Devices and Systems

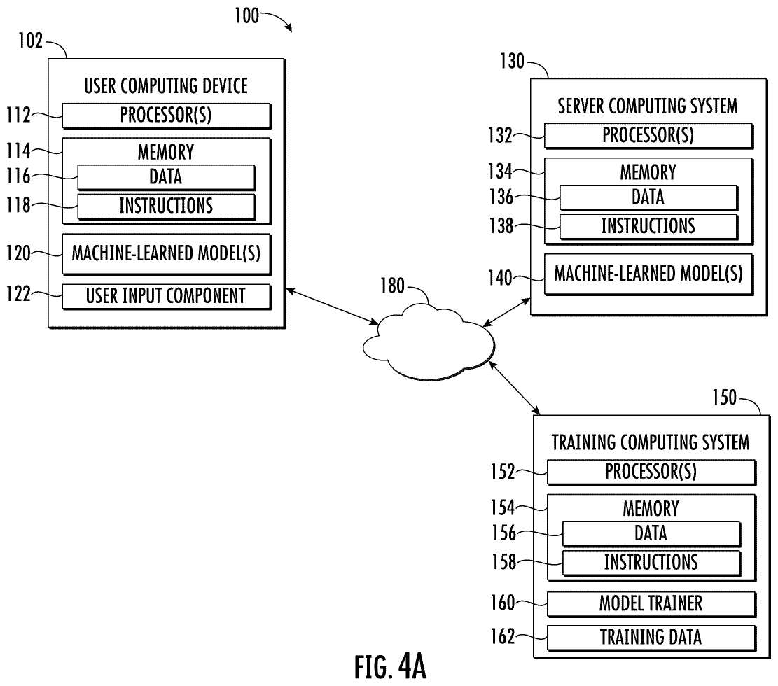

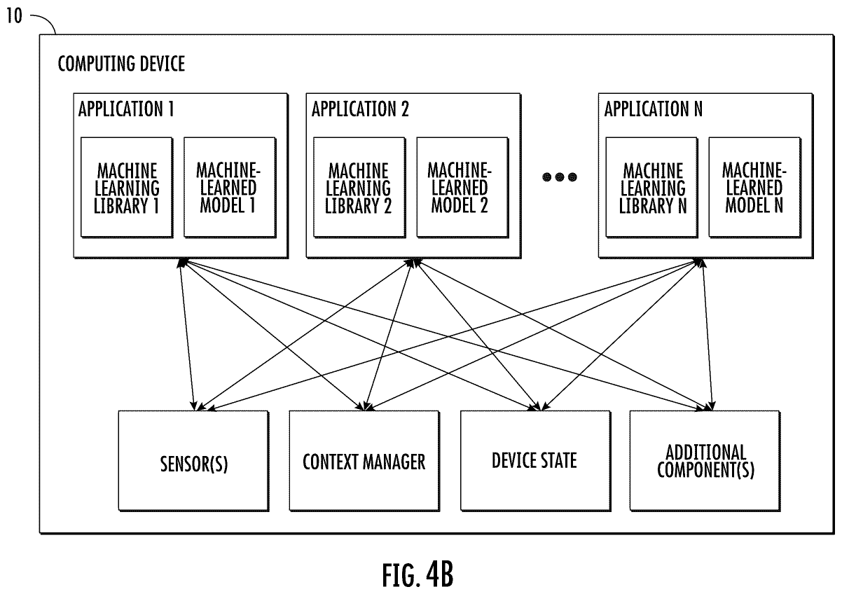

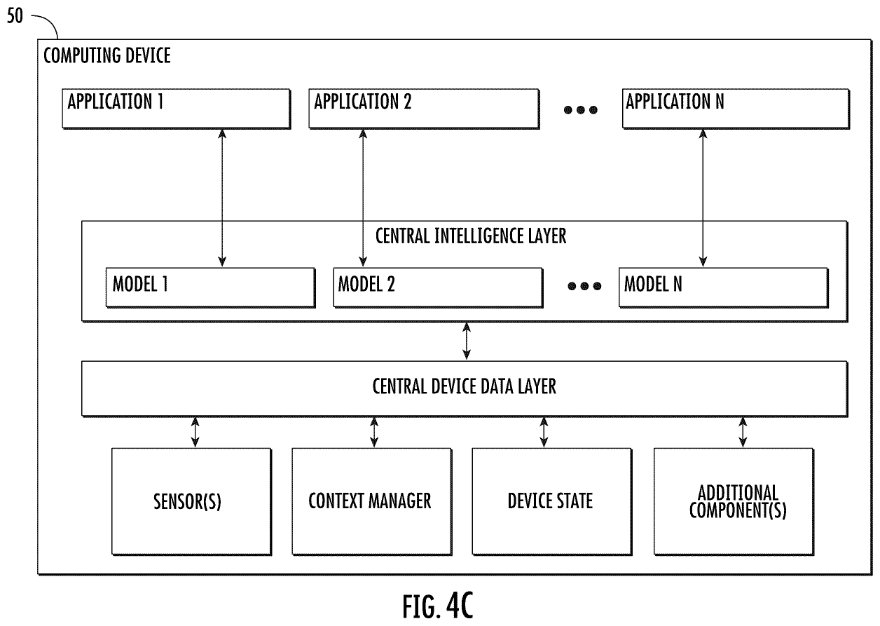

FIG. 4A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more diffusion models 120. For example, the diffusion models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more diffusion models 120 can be received from the server computing system 130 over network 180, stored in the user computing device memory 114, and then used or otherwise implemented by the one or more processors 112. In some implementations, the user computing device 102 can implement multiple parallel instances of a single diffusion model 120 (e.g., to perform parallel image synthesis across multiple instances of inputs).

Additionally or alternatively, one or more diffusion models 140 can be included in or otherwise stored and implemented by the server computing system 130 that communicates with the user computing device 102 according to a client-server relationship. For example, the diffusion models 140 can be implemented by the server computing system 140 as a portion of a web service (e.g., an image synthesis service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more diffusion models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the diffusion models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 4A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 4B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system configured to perform image generation, the computing system comprising:
one or more processors; and
one or more non-transitory computer-readable media that collectively store:
a machine-learned denoising diffusion model, wherein the machine-learned denoising diffusion model comprises:
a first downsampling block configured to process an input and perform a first downsampling operation to generate a first downsampled output;
a second downsampling block configured to process the first downsampled output and perform a second downsampling operation to generate a second downsampled output;
a transformer block configured to perform self-attention on the second downsampled output to generate a transformer output;
a first upsampling block configured to process the transformer output and perform a first upsampling operation to generate a first upsampling output; and
a second upsampling block configured to process the first upsampling output and perform a second upsampling operation to generate a second upsampling output; and
instructions that, when executed by the one or more processors, cause the computing system to use the machine-learned denoising diffusion model configured to generate images.

2. The computing system of claim 1, wherein the first downsampling block and the second upsampling block do not perform self-attention.

3. The computing system of claim 1, wherein the first downsampling block and the second upsampling block perform only convolutional operations.

4. The computing system of claim 1, wherein the transformer block is repeated multiple times.

5. The computing system of claim 1, wherein the machine-learned denoising diffusion model sequentially applies channel multipliers of 1, 2, and 4.

6. A computer-implemented method to control a machine-learned diffusion model for improved image generation, the method comprising:
obtaining, by a computing system comprising one or more computing devices, data descriptive of a specified resolution for synthetic images to be generated by the machine-learned diffusion model;
accessing, by the computing system, a noise schedule generation algorithm that outputs an output noise schedule based on an input resolution, wherein an output signal to noise ratio associated with the output noise schedule is inversely correlated to a magnitude of the input resolution;
performing, by the computing system, the noise schedule generation algorithm with the specified resolution as the input resolution to generate a resolution-specific noise schedule for the machine-learned diffusion model; and
employing, by the computing system, the machine-learned diffusion model to generate the synthetic images of the specified resolution according to the resolution-specific noise schedule.

7. The computer-implemented method of claim 6, wherein performing, by the computing system, the noise schedule generation algorithm with the specified resolution as the input resolution comprises:
obtaining, by the computing system, a reference signal to noise ratio associated with a reference noise schedule associated with a reference resolution;
determining, by the computing system, a scaling value based on the reference resolution and the specified resolution, wherein a magnitude of the scaling value is correlated to a ratio of the reference resolution to the specified resolution; and
scaling, by the computing system, the reference signal to noise ratio by the scaling value to obtain a resolution-specific signal to noise ratio for the resolution-specific noise schedule.

8. The computer-implemented method of claim 7, wherein the scaling value comprises a square of the reference resolution ratio of the reference resolution to the specified resolution.

9. The computer-implemented method of claim 7, wherein the reference resolution is smaller than the specified resolution.

10. The computer-implemented method of claim 7, wherein the reference resolution comprises 64 pixels by 64 pixels.

11. The computer-implemented method of claim 6, wherein performing, by the computing system, the noise schedule generation algorithm with the specified resolution as the input resolution comprises:
obtaining, by the computing system, a first reference signal to noise ratio associated with a first reference noise schedule associated with a first reference resolution;
determining, by the computing system, a first scaling value based on the first reference resolution and the specified resolution, wherein a magnitude of the first scaling value is correlated to a first ratio of the first reference resolution to the specified resolution;
scaling, by the computing system, the first reference signal to noise ratio by the first scaling value to obtain a first resolution-specific signal to noise ratio;
obtaining, by the computing system, a second reference signal to noise ratio associated with a second reference noise schedule associated with a second, different reference resolution;
determining, by the computing system, a second scaling value based on the second reference resolution and the specified resolution, wherein a magnitude of the second scaling value is correlated to a second ratio of the second reference resolution to the specified resolution; and
scaling, by the computing system, the second reference signal to noise ratio by the second scaling value to obtain a second resolution-specific signal to noise ratio;
wherein the resolution-specific noise schedule comprises an interpolated schedule that interpolates between the first resolution-specific signal to noise ratio and the second resolution-specific signal to noise ratio.

12. The computer-implemented method of claim 6, wherein the machine-learned diffusion model has been trained using a multi-scale training loss that evaluates loss values between downsampled versions of a training input and a predicted output at multiple reduced resolutions.

13. A computer-implemented method for improved training of diffusion models for image synthesis via multi-scale training loss, the method comprising:
accessing, by a computing system comprising one or more computing devices, a training input associated with a training image;
employing, by the computing system, a diffusion model to generate a predicted output associated with a synthetic image based at least in part on the training input associated with the training image;
evaluating, by the computing system, a multi-scale loss function based on the training input associated with the training image and the predicted output associated with the synthetic image, wherein evaluating the multi-scale loss function comprises:
downsampling both the training input and the predicted output to a plurality of reduced resolutions;
evaluating a plurality of loss values between the training input and the predicted output respectively at the plurality of reduced resolutions; and
aggregating the plurality of loss values to generate an aggregate loss value; and
updating, by the computing system, one or more parameters of the diffusion model based at least in part on the aggregate loss value.

14. The computer-implemented method of claim 13, wherein aggregating the plurality of loss values to generate the aggregate loss value comprises weighting each loss value by a weighting coefficient, wherein a magnitude of the weighting coefficient applied to the loss value at each reduced resolution is inversely correlated to the reduced resolution.

15. The computer-implemented method of claim 13, wherein the training input and the predicted output comprise respective epsilon values.

16. The computer-implemented method of claim 13, wherein the diffusion model operates according to a resolution-specific noise schedule.
